(19) United States
(12) Patent Application Publication
(10) Pub. No.: US 2016/0210367 A1
(43) Pub. Date: Jul. 21, 2016

(54) TRANSITION EVENT DETECTION

(71) Applicant: Yahoo! Inc., Sunnyvale, CA (US)

(72) Inventors: Makoto Yamada, San Jose, CA (US); Yi Chang, Milpitas, CA (US)

(21) Appl. No.: 14/601,128

(22) Filed: Jan. 20, 2015

(51) Int. Cl. G06F 17/30; H04L 12/26; G06Q 30/02

(52) U.S. Cl. CPC G06F 17/30867; G06Q 30/0201; H04L 43/10

(57) ABSTRACT

Detection of one or more transition events.

### FIELD

The subject matter disclosed herein relates generally to detection of one or more transition events.

### INFORMATION

Creating, aggregating, and/or promoting content (e.g., content creation), including, but not limited to, content related to current events (e.g., news and/or other events) has become a billion dollar industry. In this context, content consumption and/or similar terms refer to viewing, playing, sharing, and/or searching for content. Likewise, in this context, content and/or similar terms refer to text, images, video and/or audio content. By way of non-limiting example, an event, such as birth of a baby to a celebrity, may trigger consumption of content related to the event. Various techniques for detecting events are known. For example, a K-Means clustering technique may be used. However, a K-Means technique is typically not able to take temporal signal sample values (e.g., time stamps, etc.) into account. Furthermore, K-Means clustering approaches tend to result in selection of a local signal sample value, although improvement via other signal sample values are available. The HISCOVERY approach is another approach to detecting events. However, use of non-conventional language in content may lead to less accurate event detecting. By way of non-limiting example, the HISCOVERY approach overlooks hashtags, for example. Additionally, the HISCOVERY approach generally relies on a Gaussian statistic, which may not be well-suited for detecting of events.

### BRIEF DESCRIPTION OF THE DRAWINGS

Claimed subject matter is particularly pointed out and distinctly claimed in the concluding portion of the specification. However, both as to organization and/or method of operation, together with objects, features, and/or advantages thereof, it may be best understood by reference to the following detailed description if read with the accompanying drawings in which:

FIGS. 1A and 1B are plots indicating content consumption.

FIG. 2 is a block diagram illustrating an embodiment.

FIGS. 3A and 3B are graphs comparing different embodiments.

FIGS. 4A-4D are graphs comparing different embodiments.

FIGS. 5A-5E are plots comparing different embodiments.

FIG. 6 is a block diagram illustrating a device embodiment.

Reference is made in the following detailed description to accompanying drawings, which form a part hereof, wherein like numerals may designate like parts throughout to indicate corresponding and/or analogous components. It will be appreciated that components illustrated in the figures have not necessarily been drawn to scale, such as for simplicity and/or clarity of illustration. For example, dimensions of some components may be exaggerated relative to other components. Further, it is to be understood that other embodiments may be utilized. Furthermore, structural and/or other changes may be made without departing from claimed subject matter. It should also be noted that directions and/or references, for example, up, down, top, bottom, and so on, may be used to facilitate discussion of drawings and/or are not intended to restrict application of claimed subject matter. Therefore, the following detailed description is not to be taken to limit claimed subject matter and/or equivalents.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses, or systems that would be known by one of ordinary skill have not been described in detail so as not to obscure claimed subject matter.

References throughout this specification to one implementation, an implementation, one embodiment, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

With advances in technology, it has become more typical to employ distributed computing approaches in which portions of a computational problem may be allocated among computing devices, including one or more clients and one or more servers, via a computing and/or communications network, for example.

A network may comprise two or more network devices and/or may couple network devices so that signal communications, such as in the form of signal packets and/or frames, for example, may be exchanged, such as between a server and a client device and/or other types of devices, including between wireless devices coupled via a wireless network, for example.

In this context, the term network device refers to any device capable of communicating via and/or as part of a network and may comprise a computing device. While network devices may be capable of sending and/or receiving signals (e.g., signal packets and/or frames), such as via a wired and/or wireless network, they may also be capable of performing arithmetic and/or logic operations, processing and/or storing signals, such as in memory as physical memory states, and/or may, for example, operate as a server in various embodiments. Network devices capable of operating as a server, or otherwise, may include, as examples, dedicated rack-mounted servers, desktop computers, laptop computers, set top boxes, tablets, netbooks, smart phones, wearable devices, integrated devices combining two or more features of the foregoing devices, the like or any combination thereof. Signal packets and/or frames, for example, may be exchanged, such as between a server and a client device and/or other types of network devices, including between wireless devices coupled via a wireless network, for example. It is noted that the terms, server, server device, server computing device, server computing platform and/or similar terms are used interchangeably. Similarly, the terms client, client device, client computing device, client computing platform and/or similar terms are also used interchangeably. While in some instances, for ease of description, these terms may be used in the singular, such as by referring to a “client device” or a “server device,” the description is intended to encompass one or more client devices and/or one or more server devices, as appropriate. Along similar lines, references to a “database” are understood to mean, one or more databases and/or portions thereof, as appropriate.

It should be understood that for ease of description a network device (also referred to as a networking device) may be embodied and/or described in terms of a computing device. However, it should further be understood that this description should in no way be construed that claimed subject matter is limited to one embodiment, such as a computing device and/or a network device, and, instead, may be embodied as a variety of devices or combinations thereof, including, for example, one or more illustrative examples.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term coupled is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics. Likewise, the term “based on” and/or similar terms are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more examples; however, again, particular context of description and/or usage provides helpful guidance regarding inferences to be drawn.

A network may also include now known, and/or to be later developed arrangements, derivatives, and/or improvements, including, for example, past, present and/or future mass storage, such as network attached storage (NAS), a storage area network (SAN), and/or other forms of computer and/or machine readable media, for example. A network may include a portion of the Internet, one or more local area networks (LANs), one or more wide area networks (WANs), wire-line type connections, wireless type connections, other connections, or any combination thereof. Thus, a network may be worldwide in scope and/or extent. Likewise, sub-networks, such as may employ differing architectures and/or may be compliant and/or compatible with differing protocols, such as computing and/or communication protocols (e.g., network protocols), may interoperate within a larger network. In this context, the term sub-network refers to a portion and/or part of a network. Sub-networks may also comprise links, such as physical links, connecting and/or coupling nodes to transmit signal packets and/or frames between devices of particular nodes including wired links, wireless links, or combinations thereof. Various types of devices, such as network devices and/or computing devices, may be made available so that device interoperability is enabled and/or, in at least some instances, may be transparent to the devices. In this context, the term transparent refers to devices, such as network devices and/or computing devices, communicating via a network in which the devices are able to communicate via intermediate devices of a node, but without the communicating devices necessarily specifying one or more intermediate devices of one or more nodes and/or may include communicating as if intermediate devices of intermediate nodes are not necessarily involved in communication transmissions. For example, a router may provide a link and/or connection between otherwise separate and/or independent LANs. In this context, a private network refers to a particular, limited set of network devices able to communicate with other network devices in the particular, limited set, such as via signal packet and/or frame transmissions, for example, without a need for re-routing and/or redirecting network communications. A private network may comprise a stand-alone network; however, a private network may also comprise a subset of a larger network, such as, for example, without limitation, all or a portion of the Internet. Thus, for example, a private network “in the cloud” may refer to a private network that comprises a subset of the Internet, for example. Although signal packet and/or frame transmissions may employ intermediate devices of intermediate noes to exchange signal packet and/or frame transmissions, those intermediate devices may not necessarily be included in the private network by not being a source or destination for one or more signal packet and/or frame transmissions, for example. It is understood in this context that a private network may provide outgoing network communications to devices not in the private network, but such devices outside the private network may not necessarily direct inbound network communications to devices included in the private network.

The Internet refers to a decentralized global network of interoperable networks that comply with the Internet Protocol (IP). It is noted that there are several versions of the Internet Protocol. Here, the term Internet Protocol or IP is intended to refer to any version, now known and/or later developed. The Internet includes local area networks (LANs), wide area networks (WANs), wireless networks, and/or long haul public networks that, for example, may allow signal packets and/or frames to be communicated between LANs. The term world wide web (WWW or web) and/or similar terms may also be used, although it refers to a sub-portion of the Internet that complies with the Hypertext Transfer Protocol or HTTP. For example, network devices may engage in an HTTP session through an exchange of Internet signal packets and/or frames. It is noted that there are several versions of the Hypertext Transfer Protocol. Here, the term Hypertext Transfer Protocol or HTTP is intended to refer to any version, now known and/or later developed. It is likewise noted that in various places in this document substitution of the term Internet with the term World Wide Web may be made without a significant departure in meaning and may, therefore, not be inappropriate in that the statement would remain correct with such a substitution.

Although claimed subject matter is not in particular limited in scope to the Internet or to the web, it may without limitation provide a useful example of an embodiment for purposes of illustration. As indicated, the Internet may comprise a worldwide system of interoperable networks, including devices within those networks. The Internet has evolved to a public, self-sustaining facility that may be accessible to tens of millions of people or more worldwide. Also, in an embodiment, and as mentioned above, the terms “WWW” and/or “web” refer to a sub-portion of the Internet that complies with the Hypertext Transfer Protocol or HTTP. The web, therefore, in this context, may comprise an Internet service that organizes stored content, such as, for example, text, images, video, etc., through the use of hypermedia, for example. A HyperText Markup Language (“HTML”), for example, may be utilized to specify content and/or format of hypermedia type content, such as in the form of a file or an “electronic document,” such as a web page, for example. An Extensible Markup Language (“XML”) may also be utilized to specify content and/or format of hypermedia type content, such as in the form of a file or an “electronic document,” such as a web page, in an embodiment. Of course, HTML and XML are merely example languages provided as illustrations and, furthermore, HTML and/or XML is intended to refer to any version, now known and/or later developed. Likewise, claimed subject matter is not intended to be limited to examples provided as illustrations, of course.

The term “web site” and/or similar terms refer to a collection of related web pages, in an embodiment. The term “web page” and/or similar terms relates to any electronic file and/or electronic document, such as may be accessible via a network, by specifying a uniform resource locator (URL) for accessibility via the web, in an example embodiment. As alluded to above, a web page may comprise content coded using one or more languages, such as, for example, HTML and/or XML, in one or more embodiments. Although claimed subject matter is not limited in scope in this respect. Also, in one or more embodiments, developers may write code in the form of JavaScript, for example, to provide content to populate one or more templates, such as for an application. Here, JavaScript is intended to refer to any now known or future versions. However, JavaScript is merely an example programming language. As was mentioned, claimed subject matter is not limited to examples or illustrations.

Terms including “entry”, “electronic entry”, “document”, “electronic document”, “content”, “digital content”, “item”, and/or similar terms are meant to refer to signals and/or states in a format, such as a digital format, that is perceivable by a user, such as if displayed and/or otherwise played by a device, such as a digital device, including, for example, a computing device. In an embodiment, “content” may comprise one or more signals and/or states to represent physical measurements generated by sensors, for example. For one or more embodiments, an electronic document may comprise a web page coded in a markup language, such as, for example, HTML (hypertext markup language). In another embodiment, an electronic document may comprise a portion and/or a region of a web page. However, claimed subject matter is not limited in these respects. Also, for one or more embodiments, an electronic document and/or electronic entry may comprise a number of components. Components in one or more embodiments may comprise text, for example as may be displayed on a web page. Also for one or more embodiments, components may comprise a graphical object, such as, for example, an image, such as a digital image, and/or sub-objects, such as attributes thereof. In an embodiment, digital content may comprise, for example, digital images, digital audio, digital video, and/or other types of electronic documents.

Signal packets and/or frames, also referred to as signal packet transmissions and/or signal frame transmissions, and may be communicated between nodes of a network, where a node may comprise one or more network devices and/or one or more computing devices, for example. As an illustrative example, but without limitation, a node may comprise one or more sites employing a local network address. Likewise, a device, such as a network device and/or a computing device, may be associated with that node. A signal packet and/or frame may, for example, be communicated via a communication channel and/or a communication path comprising a portion of the Internet, from a site via an access node coupled to the Internet. Likewise, a signal packet and/or frame may be forwarded via network nodes to a target site coupled to a local network, for example. A signal packet and/or frame communicated via the Internet, for example, may be routed via a path comprising one or more gateways, servers, etc. that may, for example, route a signal packet and/or frame in accordance with a target and/or destination address and availability of a network path of network nodes to the target and/or destination address. Although the Internet comprises a network of interoperable networks, not all of those interoperable networks are necessarily available and/or accessible to the public.

A network protocol refers to a set of signaling conventions for computing and/or communications between and/or among devices in a network, typically network devices; for example, devices that substantially comply with the protocol and/or that are substantially compatible with the protocol. In this context, the term “between” and/or similar terms are understood to include “among” if appropriate for the particular usage. Likewise, in this context, the terms “compatible with”, “comply with” and/or similar terms are understood to include substantial compliance and/or substantial compatibility.

At times, content creators and/or distributors receive remuneration, at least in part, for advertisements associated with content, such as on pages of websites, social networking sites, and/or in audio-video items, by way of illustration. Thus, a desire for content likely to be consumed exists of creators, distributors, advertisers, etc. Typically, content related to events of interest may be of particular interest to users.

On a related point, content consumers may also desire an ability to relatively easily identify content of interest. However, a consumer of content may also use one or more social media platforms for consuming content. Thus, a content consumer may have potentially hundreds, if not thousands, of content sources providing a substantial content stream. Thus, content consumers may have a desire to identify content of particular interest out of such a stream. Similarly, there may be a desire to identify content reporting on a corresponding event, for example, to reduce redundant content.

Current approaches are unsuitable for accurately identifying topics and/or events, such as within a timeline of content consumption which typically may be relatively short, such as within a few hours of an event, if not an even shorter period. In this context, an “event” and/or similar terms refer to a happening and/or an occurrence having an associated time and place of the happening/occurrence. Likewise, distinct events and/or similar terms refer to events in which the time and/or the place do not correspond to one another (e.g., are different). Likewise, the term “topic” and/or similar terms refer to two or more distinct events in which the two or more events are related with respect to subject matter of the events. Thus, and by way of illustrative example, in one case, a topic may comprise “concerts,” and an event may comprise the “San Francisco Symphony Concert at Dolores Park.” Similarly, an upcoming concert of a popular artist in the San Francisco area, such as a Taylor Swift concert, may also comprise an event within the topic “concerts.” A different example of a topic may comprise “hurricane,” with events that may comprise “Hurricane Sandy” and “Hurricane Katrina.” In this context, the term “transition event” and/or similar terms refers to a distinct event within a topic looking forward temporally, but not backwards.

Typical methods for identifying events tend to rely on content from mainstream news sources (e.g., New York Times, Wall Street Journal, the Economist, etc.), which may comprise relatively limited amounts of content and/or sources useable for identifying events of great interest. Typically, by the time these sources report an event, it may be reasonably well-known, for example.

One approach related to transition event identification is referred to as “retrospective news event detection,” which is related to discovering previously unidentified events in historical news. See. e.g., Charles L. Wayne, Multilingual Topic Detection and Tracking: Successful Research Enabled by Corpora and Evaluation, LREC 2000 2d Int'l Conf. on Lang. Resources & Evaluation. This method proposes forming one or more bodies of content from established sources of news (e.g., newswire transcripts of news broadcasts, text from sources such as the Associated Press, NY Times, CNN, etc.). However, this approach is not likely to provide events that are sufficiently timely to be of great interest. Yet, ironically, sources of timely events may not employ conventional language, making this approach less appealing.

Another current approach referred to as HISCOVERY (HIStory disCOVERY), is discussed in an article by Li et al. Li et al., A Probabilistic Model for Retrospective News Event Detection, SIGIR 2005: Proceedings of the 28th Annual International ACM SIGIR Conference on Research and Development in Information Retrieval, Salvador, Brazil, Aug. 15-19, 2005. The HISCOVERY approach also retroactively detects unidentified events. Specifically, it uses temporal detection via a Gaussian statistic to identify events. However, similar to the previous approach, this approach is not likely to provide events that are sufficiently timely to be of great interest and, as before, sources of timely events may not employ conventional language, making this approach less appealing.

To identify events before they become reasonably well-known, it instead may be desirable to use content from one or more social media platforms. A social media platform refers to a platform to be used in general to consume content, such as content coming via a network comprising one or more online social connections. For instance, Facebook is an example social media platform in which users make friend requests to other users and accept friend requests from other users to form a network of online social connections. In the context of Facebook, content may be shared by one user and viewed by another user. Thus, both users may consume content via a network of online social connections. Twitter is another example of a social media platform. Twitter bears similarities to Facebook. For instance, it employs one or more online social connections (e.g., “follows”), however, while Facebook's “friend” system employs mutual agreement to establish an online social connection between users, on Twitter, the choice to “follow” another user (e.g., form an online social connection with another user) may be made unilaterally. Like Facebook, however, Twitter users consume content socially. The examples of Facebook and Twitter are provided by way of illustration and not limitation. As noted, social media platforms may provide timely examples of content. However, while social media content may provide larger amounts of content of interest and in a time frame before it may be well-known, non-mainstream sources of content, such as from a social media platform, may use terms and/or language that may be unconventional, which may make event detection more challenging. By way of example, current approaches for event identification may overlook hashtag labels. Also, content from social media sources may be relatively short, which may also present a challenge. For example, TWEETS are limited to 140 characters, and the median length of Tumblr posts is approximately 87 words.

Additionally, transition events may tend to be “bursty” in terms of communications about such events. That is, such communications may tend to exhibit patterns that may be described as a burst of communications within a relatively short period. A reason for this may relate to a process in which content of interest may be spread, referred to here as diffusion or as a diffusion process.

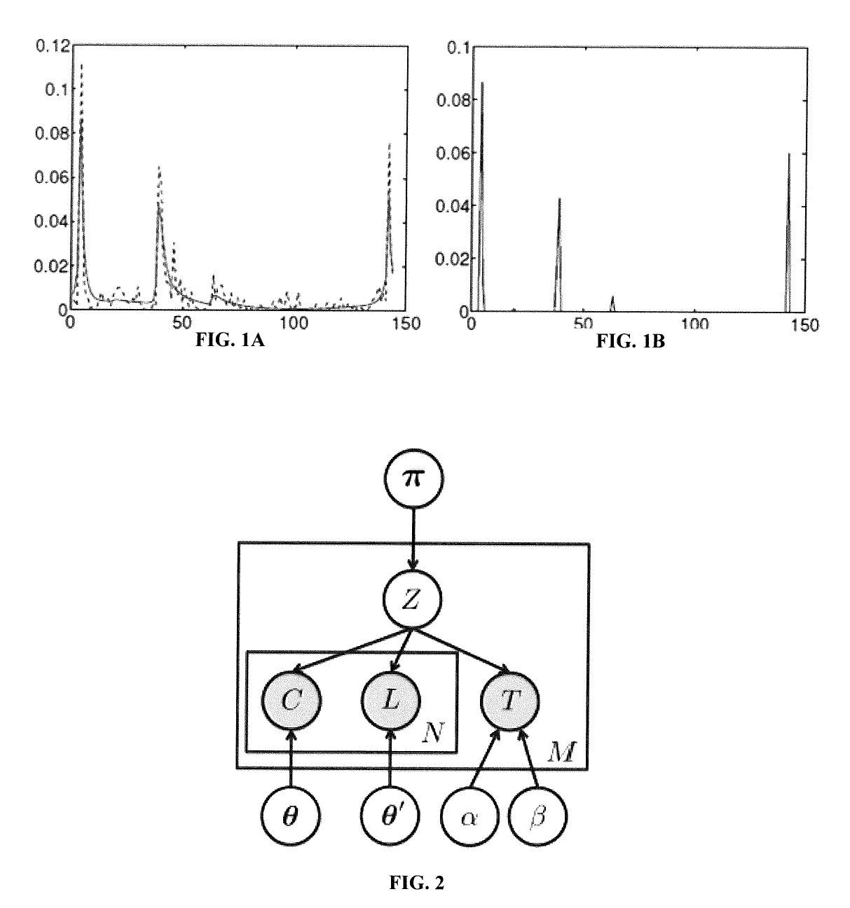

As illustrated in FIG. 1A, consumption of content related to a topic may be considered chronologically (e.g., from time t=0 to t=n, where n refers to an arbitrary unit of time). Thus, for bursty-type communications, a characteristic rising pattern may be observed, as shall be explained. A so-called spike in consumption indicates increases in consumption of content as to a topic and/or an event for a relatively short period of time, and is referred to herein as a temporal spike and/or similar terms. The x-axis of FIG. 1A illustrates consumption of content under evaluation per successive unit of time shown on the axis, while the y-axis shows mentions of a topic and/or event with respect to content under evaluation. A mention and/or similar terms refer to an occurrence of a term, such as in written or spoken language by way of non-limiting example, in one or more content samples. Thus, the y-axis is a count of total mentions within content under evaluation. The dotted line of FIG. 1A provides a measurement of mentions, while the solid line, which will be discussed hereinafter, illustrates a characteristic curve having one or more specified parameters to approximate the measurement curve, according to one embodiment.

More to the point, one example method for detecting temporal spike signals is referred to generally as burst detection. Burst detection refers to identifying abnormal signal aggregates (e.g., looking for cases where a set of aggregated signal sample values vary from a norm) in a stream of signals. Detected signal aggregates may be based, at least partly, on use of sliding windows with respect to a temporal signal stream, for example. A sliding window and/or similar terms refer to a filter that passes signals in the window, the window being contiguous, and blocks signals outside the window. Likewise, sliding refers to the movement of the window with respect to a stream of signals, such as may be arranged in a temporal successive sequence, as was described for an example embodiment. Thus, for one example embodiment, burst detection may include monitoring a plurality of sliding window sizes concurrently and identifying windows with signal patterns that vary as standing out with respect to other periods. In one non-limiting example of a burst detection embodiment, burst detection may comprise filtering one or more signals representing measurements of content consumption to reduce, for example, what may be perceived to be noise, such as smaller jagged peaks, as shown in FIG. 1A, from more significant temporal rise patterns (e.g., spikes), such as for a stream of signals regarding consumption of content as to a topic, for example. Thus, as shall be illustrated, identifying temporal spikes may facilitate differentiation of one or more distinct events of a topic (e.g., identification of a transition or a transition event), by way of non-limiting example.

For instance, a plot of content consumption as to Hurricane Sandy may show one or more distinct temporal spikes, such as Hurricane Sandy's arrival in Cuba, and Hurricane Sandy's touchdown in New Jersey. In one embodiment, it may therefore be possible to identify distinct events, and, particularly, transition events.

It is noted that a host of methods for smoothing and/or filtering signals are contemplated by claimed subject matter. The following approach is but one example, and is not to be understood in a limiting sense.

To facilitate detection of, for instance, transition events, it may be desirable to use one or more indices related to content. A temporal index may, for example, permit temporal ‘positioning’ so to speak, of events relative to other events. Likewise, mentions, such as hashtag mentions and/or non-hashtag mentions, as shall be shown, in an embodiment, may facilitate transition event detection. Using, for instance, hashtag mentions and/or non-hashtag mentions for transition event detection, may be desirable. For example, additional context may be provided to assist in detecting transition events, hence use of the term ‘contextual.’ For instance, detection of transition events substantially in accordance with detection of temporal spikes may not be entirely accurate. For instance, an initial temporal spike in mentions may be observed related to publication of an event; furthermore, dissemination of subsequent details may result in additional temporal spikes in mentions. In this case, temporal spikes without more may be misleading. Additionally, events that are not that same, but are close temporally may be a challenge to separately identify. For instance, there may be a temporal spike about an actor starring in a newly released film; approximately concurrently, the actor may be arrested. Thus, mentions of the actor may be related to the new film, or they may be related to the arrest. For at least these reasons, it may be desirable to consider hashtag and/or non-hashtag mentions additionally in identifying temporal spikes. Thus, these types of mentions may also be indexed.

An embodiment of a process of indexing is discussed here. In one non-limiting example, one or more indices may be generated for indexing content substantially according to existing methods of indexing Web content. For instance, in one non-limiting embodiment, content may be indexed based at least in part on, for example, keywords and/or other descriptive aspects as to content (e.g., parameters, format, etc.). Search engines, such as a Yahoo! search engine, by way of non-limiting example, may use one or more indices for relative quick storage and/or retrieval of content (including content-related parameters) with respect to an expansive database, for example. For convenience, indices of content for storage and/or retrieval with respect to web and/or internet related searching is referred to here as content indices. It is noted that content indices may be generated with respect to mentions, including hashtag and non-hashtag mentions.

Along these lines, one or more logs of interactions may be generated based, at least in part, on user browsing activities, such as content browsing. In one implementation, content consumption may comprise a plurality of browsing interactions. For instance, but not by limitation, a user may engage in browsing, and one or more browsing interactions may be stored as one or more physical signals and/or states, such as in a log of interactions. For example, a log of interactions may store one or more signals and/or states related to a user's IP address, a URI (e.g., a URL) of content browsed, a time and/or date of interaction, a duration of interaction, referrer/source parameters, and/or advertisement related parameters, such as advertisement ID, advertisement slot, interactions with advertisements, etc., by way of non-limiting example.

In one embodiment, it may be possible to access one or more logs of interactions to aggregate signal samples indicating consumption of content with respect to a topic and/or event. In this context, the term topical content interaction signal samples and/or similar terms refer to signal samples from interaction logs indicating consumption of content with respect to one or more topics and/or one or more events. One or more topical content interaction signal samples may correspondingly comprise contextual signal samples (e.g., hashtag-type mentions) and/or temporal parameters (e.g., time stamps), as described below, for an embodiment.

In one embodiment, a kernel (also referred to as a kernel operation) may be employed in connection with characterizing a pattern of topical content interaction signal samples, for example. As mentioned, communications regarding transition events may be ‘bursty.’ For example, topical content interaction signal samples may exhibit a rise and fall pattern comprising one or more temporal spikes, as illustrated in FIG. 1A, for example, described in more detail later. Using one or more appropriate parameters, a kernel may be used to reasonably approximate such a pattern. A kernel operation may facilitate signal processing using fewer computational resources than other potential methods, such as curve fitting, for example, since one or a few parameters may be specified to reasonably approximate a pattern of signal samples. In one embodiment, as described below, signal samples approximated using a kernel operation may be used with a Group Least Absolute Shrinkage and Selection Operator (Group Lasso)-type sparse approach to filter distinct rise patterns (e.g., temporal spikes), for example, from jagged noisy peaks that may be undesirable.

In one embodiment, as a result of signal processing, for example, one or more logs of interactions may be selected to extract indices of content for generating one or topical content interaction signal samples related to a topic, for example. By way of non-limiting example, a topic may be identified as being of interest. Thus, one or more logs of interactions, after being generated, may be scanned for mentions, which may, depending on an embodiment, include non-hashtag and hashtag mentions, for example. Thus, if “tennis” were selected as a topic, occurrences of the topic may be potentially identified, as described, for example. Topical occurrences of interest, occurrences of the topic (e.g., time stamps, URIs, etc.), and/or related parameters, for example, may be identified, extracted and/or stored in a repository, for example. Likewise, in an embodiment, a storage repository may be arranged into a plurality of categories, for convenience, such as temporal parameters, non-hashtag mentions, and hashtag mentions, for example. Regardless of particular arrangement, of course, temporal and contextual signal samples, for example, may be stored and made accessible for signal processing.

As discussed above, it may be useful to use temporal spikes, at least in part, to identify a transition event. In the context of consumption of content, a temporal signal sample may correspond to a time of content consumption. Thus, if content of a given topic and/or event is consumed 5 times, at 1:30 a.m., 6:10 a.m., 8:45 a.m., 9:00 a.m., and 11:21 a.m. on Jan. 3, 2015, then signal samples may provide time and/or date of consumption for the topic and/or event (e.g., 1:30, 6:10, 8:45, 9:00, and 11:21 a.m. on Jan. 3, 2015). Thus, in one example, one or more signal samples may relate to, for instance, a time and/or date of content consumption of a topic and/or event, and, for convenience, are referred to as temporal signal samples for the topic and/or event.

Similarly, as noted above, one or more contextual signal samples may also be useful for identifying a transition event. As used in relation to a sample of content, contextual signal samples refer to textual and/or audio-visual components of the content sample. Thus, one or more words related to a subject (e.g., person, place, event, etc.) in a content sample, as an example, comprises contextual signal samples. Thus, in one example, one or more signal samples may correspond to contextual signal samples (e.g., comprising signal samples having hashtag and/or non-hashtag values), and, for convenience, are referred to as contextual signal samples. Contextual signal samples may be extracted and/or stored in a content index, by way of example.

In an illustrative example, transition events related to the topic of “tennis,” may be sought. For instance, a content index and a temporal index may be scanned to identify one or more temporal signal samples and/or one or more contextual signal samples corresponding to “tennis.” Mentions may be plotted to yield one or more temporal spikes. For instance, temporal spikes may correspond to a Grand Slam tournament, such as Wimbledon. However, in at least some cases, temporal spikes may not correspond to transition events. However, contextual signal samples may assist in accurately identifying transition events. Thus, for instance, the bizarre exchange between Victoria Beckham and Samuel L. Jackson at the Wimbledon Men's Final in 2014 may contribute to a temporal spike containing at least two transition events: Novak Djokovic's victory over Roger Federer in the final, and Victoria Beckham's apparent awkwardness as to Mr. Jackson in the stands. Therefore, contextual signal samples may assist in making a determination regarding a transition event related to the men's final match.

Thus, in one embodiment, an index, such as a content index and/or a temporal index, may be consulted to determine a frequency of occurrence of a desired topic (e.g., mentions) over an interval of time, such as by scanning one or more temporal signal samples and/or one or more contextual signal samples in a temporal index and/or content index. By way of non-limiting example, it may be possible to focus on a desired social media platform (e.g., TWITTER) during a desired time interval, scan an index for occurrences of a desired topic, and generate one or more time-series sequences over one or more temporal intervals, comprising one or more topical content interaction signal samples.

In one non-limiting embodiment, it may be possible to employ a kernel operation to approximate a pattern (e.g., a rise and/or fall pattern) of topical content interaction signal sample S substantially in accordance with the following

$$g ( t ; w , Γ , μ ) = {\sum }_{l = 1}^{b} {w}_{l} k ( t ; {γ}_{l} , μ ) ,$$

where k(t,β,μ) comprises a basis function, μ comprises a pattern location, w comprises a weight vector for a pattern, and γₗ comprises a parameter for an l-th basis function.

The relation above may be of use since a time-series sequence as to mentions of a topic may exhibit a sharp rise and/or a comparatively slow decay, such as is shown in FIG. 1A. In this context, these rise and fall patterns are referred to as a spike and a tail (or decay) pattern (and/or similar terms), respectively. Although conventional curve fitting may not provide meaningful results, alternatively, a Gamma function may be employed as a basis function, substantially in accordance with the following:

$$k ( t ; γ , μ ) = \{ \begin{matrix}{{Z}^{- 1} ( t - μ )}^{α - 1} {e}^{- β ( t - μ )} & ( t \geq μ ) \\ 0 & ( Others )\end{matrix} ,$$

where γ=[α,β] comprise parameters to be estimated and Z comprises a normalization factor. For example, a Gamma basis function may be used to approximate a typical sharp rise by setting α, a shape parameter for a Gamma function, to a relatively small value (e.g., 1, 1.5, or 2, by way of non-limiting example.). Moreover, in one non-limiting embodiment, setting β, a rate parameter (e.g., decay parameter), to a smaller value (e.g., 0.01) may be such that a Gamma function employing these parameters may exhibit a reasonably flat decay. Conversely, setting β to a large value (e.g., 100) may be such that a Gamma function may exhibit a reasonably sharp decay. Thus, as discussed in more detail later, candidate parameters for α may comprise [1, 1.5, 2] and candidate parameters for β may comprise [0.1, 0.2, . . . , 1.0] in example embodiments.

Continuing with the approach above, a plurality of time-series sequences might have multiple patterns. Thus, a time-series sequences may be approximated using a superposition of kernels, substantially in accordance with relation (1), for an embodiment

$$\begin{matrix}f ( t ; W , Γ , μ ) = {\sum }_{p = 1}^{P} {\sum }_{l = 1}^{b} {w}_{k} , {}_{p} k ( t ; {γ}_{l} , {μ}_{p} ) ,\end{matrix} \qquad ( 1 )$$

where P comprises a count of spike and tail patterns, μₖ comprises a location of a k-th pattern, W=[w₁, . . . , w_{P}]ε [symbol] ^{d×P} denotes a set of weight vectors, and wₖ comprises a weight vector for a k-th peak.

In one embodiment, relation (1) may be used to estimate a signal pattern, in a non-limiting example. For instance, one or more parameters may be fixed, and it may be possible to iterate remaining parameters to generate a reasonable approximation. For example, a time-series sequence comprising one or more topical content interaction signal samples may be denoted as y=[y₁, . . . , y_{T}]^{T}, where T refers to length of a time-series sequence. An objective function may be used substantially in accordance with the following:

$${min}_{w , α , β , μ} {\sum }_{t = 1}^{T} {( {y}_{t} - f ( t ; W , Γ , μ ) )}^{2}$$

$$s . t . {w}_{k , l} > 0 , {μ}_{k} > 0 , k = 1 , 2 , … , L .$$

A gradient descent approach may be employed to generate a reasonable approximation in addition to some additional heuristics.

In one non-limiting embodiment, computationally, a convex function may be more easily handled. Although the relation above is non-convex, it may be possible to use a convex approximation to it. As alluded to above, for an embodiment, parameters of basis functions Γ may be fixed by using estimates of patterns of one or more time-series sequences (e.g., spike and tail patterns) and employing superposition, as was mentioned. Thus, a relation substantially in accordance with the following may be employed:

$$\begin{matrix}f ( t ; W ) = {\sum }_{p = 1}^{T} {\sum }_{l = 1}^{b} {w}_{p} , {}_{l} k ( t ; {γ}_{l} , p ) \\ = {\sum }_{p = 1}^{T} {w}_{p}^{⊤} k ( t ; Γ , p ) ,\end{matrix}$$

where k(t;Γ,p)=[k(t;γₗ,p), . . . , k(t;γ_{K},p)]^{T} and T denotes the transpose. Further simplification may be employed by recognizing that, in general, time-series sequences tend to be sparse with a few w parameters being non-zero. As such, a simplified relation of the above may be substantially in accordance with relation (2) as follows:

$$\begin{matrix}{min}_{v} {\sum }_{t = 1}^{T} {( {y}_{t} - {\sum }_{p = 1}^{T} {w}_{p}^{⊤} k ( t ; Γ , p ) )}^{2} + λ {\sum }_{p = 1}^{T} {‖ {w}_{p} ‖}_{2}\end{matrix} \\ s . t . {w}_{l , p} \geq 0 , l = 1 , 2 , … , b , p = 1 , 2 , … , T , \qquad ( 2 )$$

where Σₚ₌₁^{T}∥wₚ∥₂ comprises a group regularizer (e.g., for normalization) and λ comprises a regularization parameter. A group regularizer comprises an L₂-regularizer for w and an L₁ regularizer between groups ∥w₁∥₂, ∥w₂∥₂, . . . , ∥w_{T}∥₂. An estimated parameter w tends to be dense within a group but with few groups (e.g. w) of non-zero values. Thus, as mentioned, with scarcity, a group regularizer may be an appropriate choice for an embodiment.

After performing the foregoing, Group Lasso may be employed as a result of having a convex function. In one embodiment, a dual augmented Lagrangian (DAL) method may be employed, by way of non-limiting example. In one embodiment, it may be possible to choose L rise (e.g., spike) and fall (e.g., tail) patterns by changing a regularization parameter λ. A small number of rise and fall patterns may be selected, by way of non-limiting example.

Returning to FIGS. 1A-B, a time-series sequence obtained substantially in accordance with a Group Lasso method (where λ=0.1) is illustrated. In one embodiment, it may be possible to calculate a normalized Euclidean distance between an original curve (dotted line) and an approximate curve (solid line) in FIG. 1A. A sample time-series sequence graph in FIG. 1A was generated using the above method embodiment and, as should be apparent, the method embodiment approximation is relatively accurate. By way of non-limiting example, the generated curve (e.g., as an approximation) includes three significant temporal spikes and smooths other peaks. FIG. 1B is a plot of a normalized w parameter (magnitude) (e.g., estimated Group Lasso parameters [∥ŵ₁∥₂, ∥ŵ∥₂, . . . , ∥ŵ_{T}∥₂]). As illustrated, a w parameter may be used to detect transition events.

Returning to the example of the Wimbledon Men's Final, one or more temporal spikes may result. However, as was noted, it may be possible to use contextual signal samples (e.g., hashtag and/or non-hashtag signal sample values) to identify transition events. In one embodiment, results from the foregoing approach may be employed to identify different transition events within a topic. In one embodiment, it may be possible to identify and/or detect one or more transitions (e.g., the match and the Victoria Beckham/Samuel L. Jackson exchange) for a topic using techniques from probability and statistics, such as expectation-maximization.

As shall be demonstrated, it may be possible to take contextual signal samples, such as hashtag signal sample values, into account to identify transition events. To do this, in one example, it may be assumed that temporal parameters, hashtag mentions, and non-hashtag mentions are independent. For instance, one non-limiting embodiment may employ non-hashtag mentions (C), hashtag mentions (L), and temporal parameters (T), as illustrated by a block diagram provided in FIG. 2.

In one embodiment, it may be possible make assumptions for a topic and perform a probability calculation for use in identifying a transition event. In this illustrative example, for a topic with M posts, assume that the topic implicitly comprises K events that result from a hidden variable Z. In one example, content may be characterized by non-hashtag mentions (C), hashtag mentions (L) (e.g., including a hashtag labels), and temporal parameters (T) (e.g., a time stamp). In one non-limiting example, non-hashtag mentions of an event may follow a multinomial distribution θ, hashtag mentions of an event may follow another multinomial distribution θ′, and temporal parameters of an event may follow a Gamma distribution α, β. An illustrative example is shown in FIG. 2. It is noted in this context that non-hashtags are differentiated from hashtags. Otherwise, non-hashtag mentions may be sufficiently large to limit usefulness of considering hashtag mentions. In one embodiment, some content may be identified as not comprising a transition event; if so, it may be considered to relate to a background event. For example, some terms (e.g., popular terms such as iPhone or iPad) may experience relatively high rates of mentions over time. In the case of iPhone and iPad, for instance, the terms may be frequently found on social media platforms, and may not necessarily be tied to a particular transition event, such as, for example, announcement and/or launch of a new iPhone or iPad. For instance, a topic may comprise one or more transition events (e.g., K−1) with 1 background event.

In one embodiment, expectation-maximization may assist in identifying a transition event, such as, by using identified contextual and temporal signal samples for a computation, permitting remaining parameters to also be computed. For instance, this approach may assist in identifying transition events (e.g., k in the following description), based, at least in part, on the determined parameters. In this case, it may be possible to use an expectation-maximization (EM) approach to estimate parameters. Specifically, a probability distribution for C, L, and T (e.g., with respect content) may be substantially in accordance with the following:

$$p ( c , l , t \vert π , θ , {θ}^{′} , α , β ) = {\sum }_{k = 1}^{K} {π}_{k} p ( c \vert {θ}_{k} ) p ( l \vert {θ}_{k}^{′} ) p ( t \vert {α}_{k} , {β}_{k} ) .$$

Here, π=[π₁, . . . , π_{K}]^{T} comprises mixture weights, and

$$p ( c \vert {θ}_{k} ) = \frac{N !}{{\prod }_{i = 1}^{N} f ( {c}_{i} ) ! } {\prod }_{i = 1}^{N} {θ}_{ki}^{f ( {c}_{i} )} , \\ p ( l \vert {{θ}^{′}}_{k} ) = \frac{N !}{{\prod }_{i = 1}^{N} f ( {l}_{i} ) ! } {\prod }_{i = 1}^{N} {θ}_{ki}^{f ( {l}_{i} )} , \\ p ( t \vert {α}_{k} , {β}_{k} ) = \frac{{β}_{k}^{α k}}{Γ ( {α}_{k} )} {t}^{{α}_{k} - 1} {e}^{- {β}_{k} t} , \\ Γ ( a ) = {\int }_{0}^{∞} {t}^{a - 1} {e}^{- t} d t ,$$

comprise Multinomial and Gamma distributions, and f(cᵢ) refers to the term frequency of a token non-hashtag value, cᵢ. A maximum likelihood estimation may be formulated substantially in accordance with the following:

$${max}_{π , θ , {θ}^{′} , α , β} {\sum }_{j = 1}^{M} log p ( {c}_{j} , {l}_{j} , {t}_{j} \vert π , θ , {θ}^{′} , α , β )$$

$$s . t . {\sum }_{k = 1}^{K} {π}_{k} = 1 , {θ}_{jk} > 0 , {θ}_{jk}^{′} > 0 , {α}_{k} > 0 , {β}_{k} > 0.$$

unknown parameters may be calculated using parameters π, θ, θ′, α, β that are estimated. A likelihood function may be formulated substantially in accordance with the following:

$$p ( C , L , T , Z \vert π , θ , {θ}^{′} , α , β ) = {\prod }_{k = 1}^{K} {\prod }_{j = 1}^{M} [ {π}_{k} \times \frac{N !}{{\prod }_{i = 1}^{N} f ( {c}_{ij} ) !} {\prod }_{i = 1}^{N} {θ}_{ki}^{f ( {c}_{ji} )} \times {\frac{N !}{{\prod }_{i = 1}^{N} f ( {l}_{ij} ) !} {\prod }_{i = 1}^{N} {{θ}^{′}}_{ki}^{f ( {l}_{ji} )} \times \frac{{β}_{k}^{{α}_{k}}}{Γ ( {α}_{k} )} {t}_{j}^{{α}_{k} - 1} {e}^{- {β}_{k} {t}_{j}} ]}^{z} kj ,$$

where Z=[z₁, . . . , z_{N}] comprises a set of latent vectors. An expectation of a log-likelihood function (a.k.a., Q function) may be formulated substantially in accordance with

$$\begin{matrix}Q {=}^{Δ} {E}_{Z} [ log p ( C , L , T , Z \vert π , θ , {θ}^{′} , α , β ) ] \\ = {\sum }_{k = 1}^{K} {\sum }_{j = 1}^{N} \{ {γ}_{kj} log {π}_{k} + {γ}_{kj} log {α}_{k} log {β}_{k} - {γ}_{kj} log Γ ( {a}_{k} ) + \\ {γ}_{kj} ( {α}_{k} - 1 ) log {t}_{j} - {γ}_{kj} {β}_{k} {t}_{j} + 2 {γ}_{kj} log ( N ! ) - \\ {γ}_{kj} {\sum }_{i = 1}^{N} log [ f ( {c}_{ji} ) ! ] + {γ}_{kj} {\sum }_{i = 1}^{N} f ( {c}_{ji} ) log {θ}_{ki} - \\ {γ}_{kj} {\sum }_{i = 1}^{N} log [ f ( {l}_{ji} ) ! ] + {γ}_{kj} {\sum }_{i = 1}^{N} f ( {l}_{ji} ) log {θ}_{ki}^{′} \} ,\end{matrix}$$

where γₖⱼ=E[zₖⱼ] comprises posterior probability. The foregoing Q function may identify hashtag clusters substantially in accordance with the distributions and thereby facilitate a result that corresponds with observed measurements. Thus, taking one or more hashtag mentions into account, potentially leads to better accuracy as to identification of transition events, among other things.

### E-Operation:

An E-operation of an EM method comprises computation of posterior probability substantially in accordance with:

$$\begin{matrix}{γ}_{kj} = \frac{{π}_{k} p ( {c}_{j} \vert {θ}_{k} ) p ( {l}_{j} \vert {θ}_{k}^{′} ) p ( {t}_{j} \vert {α}_{k} , {β}_{k} )}{{\sum }_{l = 1}^{K} {π}_{l} p ( {c}_{j} \vert {θ}_{l} ) p ( {l}_{j} \vert {θ}_{l}^{′} ) p ( {t}_{j} \vert {α}_{l} , {β}_{l} )} .\end{matrix} \qquad ( 3 )$$

M-Operation:

An M-operation of an EM method comprises use of a maximum likelihood estimation for parameters of the Q function. To handle complexity, an M-operation may be performed in sub parts. If in closed form, it may be updated directly; otherwise, iterations may be used until satisfactory convergence occurs

For a parameter αₖ in a Gamma distribution, a maximum likelihood estimation of the Q function may be used with respect to αₖ. However, in one embodiment, maximum likelihood estimation of a Gamma distribution may not be available in closed form, and, thus, an iterative approach to parameter estimation may be employed. In an embodiment, gradient ascent may be used iteratively until satisfactory convergence is reached. In this example, gradient ascent with respect to a may be computed substantially in accordance with

$$\frac{\partial Q}{\partial {α}_{k}} = {\sum }_{j = 1}^{M} {γ}_{jk} \{ log {β}_{k} - \frac{1}{Γ ( {α}_{k} )} \frac{\partial Γ ( {α}_{k} )}{\partial {α}_{k}} + log {t}_{j} \} .$$

Thus, αₖ may be updated until satisfactory convergence substantially in accordance with:

$$\begin{matrix}{α}_{k} = {α}_{k}^{old} + η \frac{\partial Q}{\partial {α}_{k}}\end{matrix} \qquad ( 4 )$$

where η>0 comprises an incremental size parameter. For choosing an incremental size, a line search method known as Armijo's rule may be used.
βₖ parameters may be estimated substantially in accordance with

$$\begin{matrix}{β}_{k} = \frac{{\sum }_{j = 1}^{M} {γ}_{kj} {α}_{k}}{{\sum }_{j = 1}^{M} {γ}_{kj} {t}_{j}} .\end{matrix} \qquad ( 5 )$$

Next, a derivative with respect to θₖᵢ, which follows the Multinomial distribution, may be computed. To take the sum-to-one constraint into account, a Lagrange multiplier λ may be used substantially in accordance with the following:

$${Q}^{′} = Q + λ ( {\sum }_{i = 1}^{N} {θ}_{ki} - 1 ) .$$

Taking the derivative with respect to θₖᵢ and setting to zero, leads to:

$${θ}_{ki} = \frac{{\sum }_{j = 1}^{M} {γ}_{ki} f ( {c}_{ji} )}{{\sum }_{j = 1}^{M} [ {γ}_{kj} {\sum }_{i = 1}^{N} f ( {c}_{ji} ) ]} .$$

So that θₖᵢ does not reduce to zero, a smoothing form substantially in accordance with the following may be used:

$$\begin{matrix}{θ}_{ki} = \frac{1 + {\sum }_{j = 1}^{M} {γ}_{ki} f ( {c}_{ji} )}{N + {\sum }_{j = 1}^{M} [ {γ}_{kj} {\sum }_{i = 1}^{N} f ( {c}_{ji} ) ]} .\end{matrix} \qquad ( 6 )$$

Similarly, θ′ₖᵢ and πₖ may be estimated substantially in accordance with the following:

$$\begin{matrix}\begin{matrix}{θ}_{ki}^{′} = \frac{1 + {\sum }_{j = 1}^{M} {γ}_{ki} f ( {l}_{ji} )}{N + {\sum }_{j = 1}^{M} [ {γ}_{kj} {\sum }_{i = 1}^{N} f ( {l}_{ji} ) ]} .\end{matrix} & ( 7 ) \\ \begin{matrix}{π}_{k} = \frac{1}{M} {{\sum }^{M}}_{j = 1} {γ}_{kj} .\end{matrix} & ( 8 )\end{matrix}$$

The above method embodiment comprising an E-operation and an M-operation may be such that an E-operation corresponds to relation (3), and an M-operation corresponds to relations (4-8). Finally, a jth content sample may be clustered using posterior probability substantially in accordance with the following:

$$\hat{{k}_{j}} = {argmax}_{k} {γ}_{kj} .$$

Rather than employing K-Means clustering, an alternative embodiment comprises initialization using Group Lasso substantially in accordance with the following:

1: Fit a time-series sequence y using a Group Lasso type estimation, and obtain [ŵ₁, . . . , ŵ_{T}];
2: Compute a magnitude of estimated Group Lasso parameters w, e.g., [∥ŵ₁∥₂, . . . , ∥ŵ_{T}∥₂;
3: Select top K−1 Group Lasso parameters by ranking magnitude w, e.g., [∥ŵ₁∥₂, . . . , ∥ŵ_{T}∥₂], with a label 1, . . . , K−1, where a label refers to an event. Based at least in part on ranking magnitude, may be assigned to corresponding temporal parameters (e.g., time stamps), and a remaining label may be assigned as a background event. The assigned labels may be used as an initialization index. Use of Group Lasso for index initialization potentially may provide better results since non-hashtags, hashtags and temporal parameters are considered.

A method embodiment discussed above assumes that a number of events K (e.g., K−1 transition events and 1 background event) is known in advance. It is noted, however, that typically, this may not be the case. In one implementation, an approach for determining K may comprise employing training of an embodiment, such as previously discussed, for a training set of logs of interactions. Log-likelihood may be computed with varying coefficients to approximate parameters, including K.

In an alternate embodiment, to perhaps have less complexity, a Minimum Description Length (MDL) approach may be used to select K substantially in accordance with the following:

$$\begin{matrix}k = {argmin}_{k} \{ - log ( p ( X \vert Θ ) ) + {L}_{k} log ( \sqrt{M} ) \} , \\ {L}_{k} = 3 K + 2 NK ,\end{matrix} \qquad ( 9 )$$

where log(p(X|Θ) represents a log-likelihood in accordance with the approach discussed above, which may be computed via cross-validation. It is noted that −log(p(X|Θ))+Lₖ log(√M) comprises a negative MDL score.

TABLE 1
Sets for Evaluation

| Topic | #Posts | #Events | Transition Events Summary |
|---|---|---|---|
| Andy | 684.9k | 13 | Wimbledon Round 1 → Round 2 → Round |
| Murray | | | 3 → Round 4 (suspend, resume) → Round 5 |
| | | | Semifinal → Wimbledon Final → Olympics |
| | | | Round 1 → Round 2 → Round 3 → Round |
| | | | 4 → Semifinal → Olympics Final |
| David | 20.8k | 10 | Wimbledon Round 3 → Round 4 → Round |
| Ferrer | | | 5 (lose) → Swedish Open Final → Olympics |
| | | | Round 1 → Round 2 → Round 3 (lose) → |
| | | | Men-double Quarterfinal → Men-double |
| | | | Semifinal → Olympics Men-double Bronze |
| | | | Medal Match |
| Maria | 72.9k | 11 | Wimbledon Round 1 → Round 2 (suspend, |
| Sharapova | | | resume) → Round 3 → Round 4(lose) → |
| | | | Olympic Ceremony Flag-bearer → Olympic |
| | | | Round 1 → Round 2 → Round 3 → Round |
| | | | 4 → Semifinal → Olympic Final |
| Roger | 336.9k | 13 | Wimbledon Round 1 → Round 2 → Round |
| Federer | | | 3 → Round 4 → Round 5 → Semifinal → |
| | | | Wimbledon Final → Olympics Round 1 → |
| | | | Round 2 → Round 3 → Round 4 → |
| | | | Semifinal → Olympics Final |

As Table 1 shows, for evaluation purposes, 4 separate sets of content samples were gathered, where the sets of sample content map to a topic. For this example, 1.12 million social media content samples were collected for 4 topics: professional tennis players Andy Murray, David Ferrer, Maria Sharapova, and Roger Federer, spanning dates from Jun. 22 to Aug. 7, 2012. This time interval corresponds to two notable tennis events: Wimbledon and the London Olympics. Murray and Federer were selected since they were finalists at both Wimbledon and the London Olympics. Sharapova was selected because she is one of the popular female tennis players, and won the silver medal at the London Olympics. David Ferrer was selected as a control since he is comparatively less well-known than the other 3 players, has comparatively fewer mentions and/or mentions at a lower frequency, thus permitting verification of robustness of an embodiment by using sets of sample content of differing sizes. For this example, different transition events identified were Wimbledon and/or Olympic-related events. Non-sport related events (e.g., gossip, etc.) were discarded. For the topics, it is assumed that content is generated on the same day as the transition event having the event label. Table 1 summarizes the 4 sets of samples, as mentioned. It is noted that #Events refers to the number of transition events, and some events cover 2 days. #Posts refers to the number of content samples related to a topic.

In view of the relatively large volume, the computational cost for the EM method may likewise be relatively large. To at least partially address this, stopwords were removed (e.g., filtered words substantially in accordance with existing methods), multiple content items were grouped with corresponding time stamps into one concatenated document, and a total number of concatenated documents was limited to less than 10 thousand. Furthermore, terms were stored based, at least in part, on their overall frequency within a topic, and a top 1% of non-hashtag terms were chosen for a vector C, and top 1% of hashtag terms were chosen for a vector L. Furthermore, the granularity of time-series sequences used is per hour, so that sets of sample content from June 22 to August 7 comprise a 1128-dimension time-series sequence.

One or more metrics for evaluation may be used as described hereinafter. This discussion is provided to give context for understanding the results. Thus, in one embodiment, it may be possible to use a contingency table in Table 2 to arrive at the following basic metrics, where TP/FP refers to true positive and false positive and TN/FN refer to true negative and false negative.

$$Precision \text{:} P = \frac{TP}{TP + FP}$$

$$Recall \text{:} R = \frac{TP}{TP + FN}$$

$$F 1 \text{-} Score \text{:} F 1 = \frac{2 PR}{P + R}$$

$$Rand Index \text{:} RI = \frac{TP + TN}{TP + FP + TN + FN}$$

As one method embodiment comprises a clustering approach, it may be possible to use two widely used clustering evaluation metrics, Normalized Mutual Information (NMI) and Adjusted Rand Index (ARI), where ARI is the corrected-for-chance version of Rand Index.

In one embodiment, performance as to the background cluster may be ignored, and Precision-Recall may be adopted as the metric for detection of transition events. In one non-limiting embodiment, the micro metrics may be computed by summing contingency tables of all K−1 transition events, while the macro metrics may be computed by averaging metrics for transition events. For cases such as this one where the number of content items for transition events may be unbalanced, it may be possible to consider the macro metrics as the primary metrics, and micro metrics as the secondary metrics.

TABLE 2
Clustering Contingency Table

| #Posts | Labeled | Labeled not |
|---|---|---|
| Predicted | TP | FP |
| Predicted not | FN | TN |

For purposes of comparison, the following methods are used on the four sets of sample content discussed above:
K-Means: computed K-Means
Hiscovery: for person, location, keyword use 3 independent multinomial distributions, and for temporal parameter use Gaussian distribution.
Embodiment with K-Means initialization: used the K-Means results as the index initialization of an embodiment, as discussed above.
Embodiment with Group Lasso initialization: use Group Lasso method embodiment, as discussed above.

For purposes of simplicity, we assume the number of transition events, K−1, for each topic is known in advance, and compare different approaches over so-called ground truth.

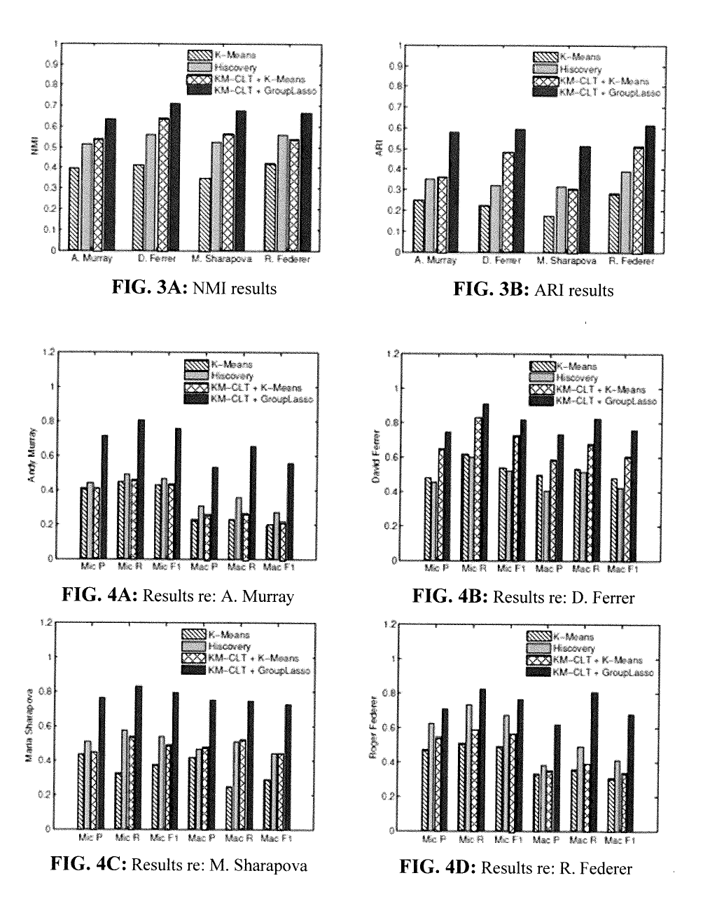

FIGS. 3A and 3B illustrate a comparison of the clustering results of each method using ARI and NMI metrics. As shown, K-Means performs the worst of the four, likely because temporal values are not considered. A method embodiment using K Means initialization outperforms Hiscovery nearly every time. Finally, as illustrated, a method embodiment using Group Lasso initialization consistently performed better than ARI and NMI metrics.

Because background events also contribute to ARI metrics, they were removed and the precision-recall metrics illustrated in FIGS. 4A-4D were generated. Note first that clustering evaluation results and precision-recall evaluation results are not consistent. In FIGS. 4A-4D, Hiscovery outperforms a method embodiment using K-means initialization on 2 sets of sample content, performs worse on 1 set of sample content, and on par on the remaining set of sample content. As should be apparent, the method embodiment using Group Lasso initialization consistently outperformed under each metrics and for all topics.

As noted above, in an uncontrolled application of transition event identification, the number of transition events is typically not known. In one embodiment, the Minimal Description Length (MDL) approach, discussed above, may yield useful results.

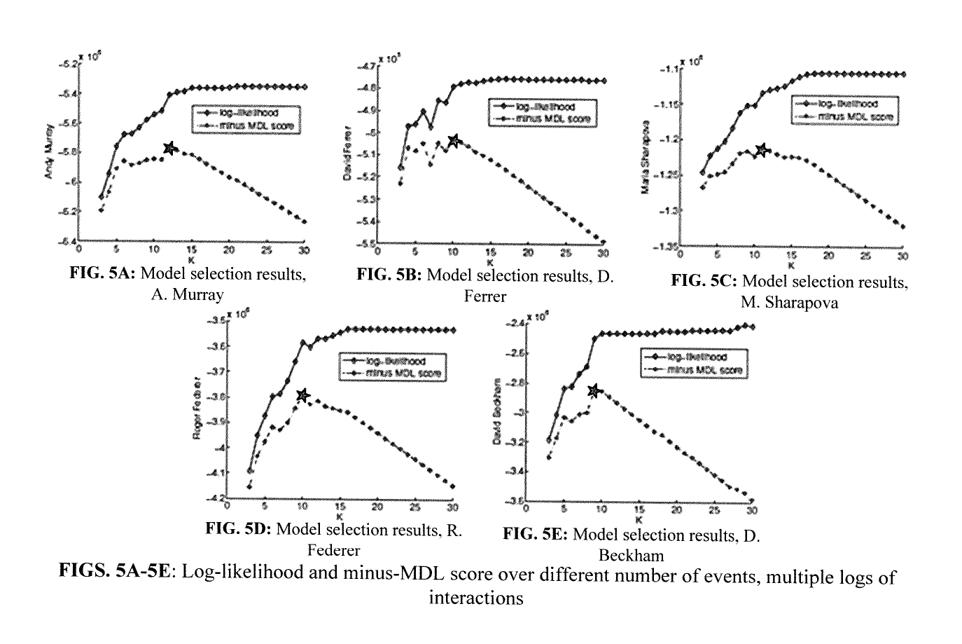

FIGS. 5A-BD illustrate the MDL results on the 4 sets sample content discussed above, where x-axis refers the number of events K, which corresponds to the number of transition events plus one background event, and the starred point refers to the selection result for a number of K. As K increases, the log-likelihood also increases (solid line on top). It is noted that in one embodiment, the log-likelihood score may not fluctuate as K reaches a threshold because Group Lasso is a convex approach. After penalizing the log-likelihood due to complexity, we find numbers of transition events as follows: 11 transition events in Andy Murray topic, 9 in David Ferrer topic, 10 in Sharapova topic, and 9 transition events in Federer topic, which are very close to our manual labeled ground truth in Table 1.

In a further embodiment, a set of signal sample values related to topic “David Beckham” is used covering the same temporal period used above (e.g., from Jun. 22 to Aug. 7, 2012). Of note, since Beckham was not participating as an athlete at any major events occurring during this interval of time, this allows further testing of robustness.

For this example, 381.5 k content samples regarding David Beckham were collected for the time period from Jun. 22 to Aug. 7, 2012. These content samples were evaluated over different numbers of events. Looking at FIG. 5E, based on MDL principal, the number of K appears to be 9. It may therefore be concluded, in this example, that the number of transition events is 8 (e.g., K−1). The transition events are analyzed according to the most consumed content, and summarized on Table 3.

TABLE 3
Topic Transition of David Beckham

| Date | Transition Event Summary |
|---|---|
| June 28 | Beckham not picked for British Olympic soccer team |
| July 8 | Beckhams shown at Wimbledon watching match |
| July 11 | Beckham Tom Cruise have been photographed together by press |
| July 12 | Rumor about Beckham joining FC Chelsea team |
| July 15 | Beckham scores goal for LA Galaxy team |
| July 24 | Beckham Photobombs Londoners for Adidas |
| July 27 | Beckham at London Olympic Opening Ceremony |
| July 29 | People talking about Beckham not being chosen by |
| | British Olympic soccer team |

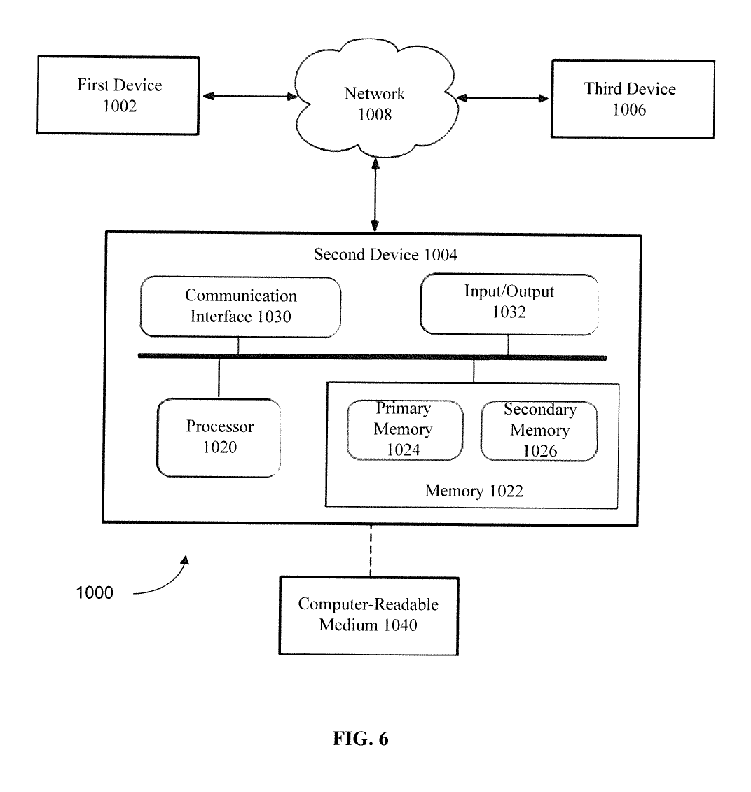

For purposes of illustration, FIG. 6 is an illustration of an embodiment of a system 1000 that may be employed in a client-server type interaction, such as described infra. in connection with identifying a transition event via a device, such as a network device and/or a computing device, for example. In FIG. 6, computing device 1002 (‘first device’ in figure) may interface with client 1004 (‘second device’ in figure), which may comprise features of a client computing device, for example. Communications interface 1030, processor (e.g., processing unit) 1020, and memory 1022, which may comprise primary memory 1024 and secondary memory 1026, may communicate by way of a communication bus, for example. In FIG. 6, client computing device 1002 may represent one or more sources of analog, uncompressed digital, lossless compressed digital, and/or lossy compressed digital formats for content of various types, such as video, imaging, text, audio, etc. in the form physical states and/or signals, for example. Client computing device 1002 may communicate with computing device 1004 by way of a connection, such as an internet connection, via network 1008, for example. Although computing device 1004 of FIG. 6 shows the above-identified components, claimed subject matter is not limited to computing devices having only these components as other implementations may include alternative arrangements that may comprise additional components or fewer components, such as components that function differently while achieving similar results. Rather, examples are provided merely as illustrations. It is not intended that claimed subject matter to limited in scope to illustrative examples.

Processor 1020 may be representative of one or more circuits, such as digital circuits, to perform at least a portion of a computing procedure and/or process. By way of example, but not limitation, processor 1020 may comprise one or more processors, such as controllers, microprocessors, microcontrollers, application specific integrated circuits, digital signal processors, programmable logic devices, field programmable gate arrays, the like, or any combination thereof. In implementations, processor 1020 may perform signal processing to manipulate signals and/or states, to construct signals and/or states, etc., for example.

Memory 1022 may be representative of any storage mechanism. Memory 1020 may comprise, for example, primary memory 1022 and secondary memory 1026, additional memory circuits, mechanisms, or combinations thereof may be used. Memory 1020 may comprise, for example, random access memory, read only memory, etc., such as in the form of one or more storage devices and/or systems, such as, for example, a disk drive, an optical disc drive, a tape drive, a solid-state memory drive, etc., just to name a few examples. Memory 1020 may be utilized to store a program. Memory 1020 may also comprise a memory controller for accessing computer readable-medium 1040 that may carry and/or make accessible content, which may include code, and/or instructions, for example, executable by processor 1020 and/or some other unit, such as a controller and/or processor, capable of executing instructions, for example.

Under direction of processor 1020, memory, such as memory cells storing physical states, representing, for example, a program, may be executed by processor 1020 and generated signals may be transmitted via the Internet, for example. Processor 1020 may also receive digitally-encoded signals from client computing device 1002.

Network 1008 may comprise one or more network communication links, processes, services, applications and/or resources to support exchanging communication signals between a client computing device, such as 1002, and computing device 1006 (‘third device’ in figure), which may, for example, comprise one or more servers (not shown). By way of example, but not limitation, network 1008 may comprise wireless and/or wired communication links, telephone and/or telecommunications systems, Wi-Fi networks, Wi-MAX networks, the Internet, a local area network (LAN), a wide area network (WAN), or any combinations thereof.

The term “computing device,” as used herein, refers to a system and/or a device, such as a computing apparatus, that includes a capability to process (e.g., perform computations) and/or store content, such as measurements, text, images, video, audio, etc. in the form of signals and/or states. Thus, a computing device, in this context, may comprise hardware, software, firmware, or any combination thereof (other than software per se). Computing device 1004, as depicted in FIG. 6, is merely one example, and claimed subject matter is not limited in scope to this particular example. For one or more embodiments, a computing device may comprise any of a wide range of digital electronic devices, including, but not limited to, personal desktop and/or notebook computers, high-definition televisions, digital versatile disc (DVD) players and/or recorders, game consoles, satellite television receivers, cellular telephones, wearable devices, personal digital assistants, mobile audio and/or video playback and/or recording devices, or any combination of the above. Further, unless specifically stated otherwise, a process as described herein, with reference to flow diagrams and/or otherwise, may also be executed and/or affected, in whole or in part, by a computing platform.

Memory 1022 may store cookies relating to one or more users and may also comprise a computer-readable medium that may carry and/or make accessible content, including code and/or instructions, for example, executable by processor 1020 and/or some other unit, such as a controller and/or processor, capable of executing instructions, for example. A user may make use of an input device, such as a computer mouse, stylus, track ball, keyboard, and/or any other similar device capable of receiving user actions and/or motions as input signals. Likewise, a user may make use of an output device, such as a display, a printer, etc., and/or any other device capable of providing signals and/or generating stimuli for a user, such as visual stimuli, audio stimuli and/or other similar stimuli.

A computing and/or network device may include and/or may execute a variety of now known and/or to be developed operating systems, derivatives and/or versions thereof, including personal computer operating systems, such as a Windows, OS X, Linux, a mobile operating system, such as iOS, Android, Windows Phone, and/or the like. A computing device and/or network device may include and/or may execute a variety of possible applications, such as a client software application enabling communication with other devices, such as communicating one or more messages and/or content items, such as via protocols suitable for transmission of email, short message service (SMS), and/or multimedia message service (MMS), including via a network, such as a social network including, but not limited to, Facebook, LinkedIn, Twitter, Flickr, and/or Google+, to provide only a few examples. A computing and/or network device may also include and/or execute a software application to communicate content, such as, for example, textual content, multimedia content, and/or the like. A computing and/or network device may also include and/or execute a software application to perform a variety of possible tasks, such as browsing, searching, playing various forms of content, including locally stored and/or streamed video, and/or games such as, but not limited to, fantasy sports leagues. The foregoing is provided merely to illustrate that claimed subject matter is intended to include a wide range of possible features and/or capabilities.

Algorithmic descriptions and/or symbolic representations are examples of techniques used by those of ordinary skill in the signal processing and/or related arts to convey the substance of their work to others skilled in the art. An algorithm is here, and generally, is considered to be a self-consistent sequence of operations and/or similar signal processing leading to a desired result. In this context, operations and/or processing involve physical manipulation of physical quantities. Typically, although not necessarily, such quantities may take the form of electrical and/or magnetic signals and/or states capable of being stored, transferred, combined, compared, processed or otherwise manipulated as electronic signals and/or states representing various forms of content, such as signal measurements, text, images, video, audio, etc. It has proven convenient at times, principally for reasons of common usage, to refer to such physical signals and/or physical states as bits, values, elements, symbols, characters, terms, numbers, numerals, measurements, content and/or the like. It should be understood, however, that all of these and/or similar terms are to be associated with appropriate physical quantities and are merely convenient labels. Unless specifically stated otherwise, as apparent from the preceding discussion, it is appreciated that throughout this specification discussions utilizing terms such as “processing,” “computing,” “calculating,” “determining”, “establishing”, “obtaining”, “identifying”, “selecting”, “generating”, and/or the like may refer to actions and/or processes of a specific apparatus, such as a special purpose computer and/or a similar special purpose computing and/or network device. In the context of this specification, therefore, a special purpose computer and/or a similar special purpose computing and/or network device is capable of processing, manipulating and/or transforming signals and/or states, typically represented as physical electronic and/or magnetic quantities within memories, registers, and/or other storage devices, transmission devices, and/or display devices of the special purpose computer and/or similar special purpose computing and/or network device. In the context of this particular patent application, as mentioned, the term “specific apparatus” may include a general purpose computing and/or network device, such as a general purpose computer, once it is programmed to perform particular functions pursuant to instructions from program software.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and/or storage of charge or a release of stored charge. Likewise, in other memory devices, a change of state may comprise a physical change, such as a transformation in magnetic orientation and/or a physical change and/or transformation in molecular structure, such as from crystalline to amorphous or vice-versa. In still other memory devices, a change in physical state may involve quantum mechanical phenomena, such as, superposition, entanglement, and/or the like, which may involve quantum bits (qubits), for example. The foregoing is not intended to be an exhaustive list of all examples in which a change in state form a binary one to a binary zero or vice-versa in a memory device may comprise a transformation, such as a physical transformation. Rather, the foregoing is intended as illustrative examples.

In the preceding description, various aspects of claimed subject matter have been described. For purposes of explanation, specifics, such as amounts, systems and/or configurations, as examples, were set forth. In other instances, well-known features were omitted and/or simplified so as not to obscure claimed subject matter. While certain features have been illustrated and/or described herein, many modifications, substitutions, changes and/or equivalents will now occur to those skilled in the art. It is, therefore, to be understood that the appended claims are intended to cover all modifications and/or changes as fall within claimed subject matter.

One skilled in the art will recognize that a virtually unlimited number of variations to the above descriptions are possible, and that the examples and the accompanying figures are merely to illustrate one or more particular implementations for illustrative purposes. They are not therefore intended to be understood restrictively.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method comprising:
identifying, using one or more network-connected special purpose computing devices, a transition event based, at least in part, on detection of one or more temporal spikes corresponding to a topic and based, at least in part, on associating one or more contextual signal samples with the one or more temporal spikes.

2. The method of claim 1, wherein said one or more contextual signal samples comprise one or more hashtag signal sample values.

3. The method of claim 1, wherein said identifying said transition event comprises use of a superposition of Gamma functions to detect said one or more temporal spikes.

4. The method of claim 1, wherein said identifying said transition event comprises clustering mentions of said topic based, at least in part, on said one or more temporal signal samples.

5. The method of claim 4, wherein said clustering is based at least in part on a Gamma function.

6. The method of claim 1, wherein said detection of said one or more temporal spikes is based at least in part on use of a Group Lasso process.

7. The method of claim 1, wherein said detection of one or more temporal spikes corresponding to a topic comprises using a superposition of Gamma functions to approximate a rise and/or fall pattern of mentions of said topic; and
wherein said associating one or more contextual signal samples with said one or more temporal spikes comprises employing said one or more contextual signal samples in connection with a probability computation.

8. The method of claim 7, wherein said probability computation employs an expectation maximization approach.

9. A system comprising:
a device; said device to identify a transition event to be based, at least in part, on detection of one or more temporal spikes corresponding to a topic and to be based, at least in part, on an association of one or more contextual signal samples with the one or more temporal spikes.

10. The system of claim 9, wherein said one or more contextual signal samples are to comprise one or more hashtag signal sample values.

11. The system of claim 9, wherein to identify said transition event is to comprise use of a superposition of Gamma functions to detect said one or more temporal spikes.

12. The system of claim 9, wherein to identify said transition event is further to cluster mentions of said topic to be based, at least in part, on said one or more temporal signal samples.

13. The system of claim 12, wherein to cluster mentions is to be based at least in part on a Gamma function.

14. The system of claim 9, wherein said detection of said one or more temporal spikes is to be based at least in part on use of a Group Lasso process.

15. The system of claim 9, wherein said detection of one or more temporal spikes corresponding to said topic is to comprise use of a superposition of Gamma functions to approximate a rise and/or fall pattern of mentions of said topic; and
wherein said association of one or more contextual signal samples with said one or more temporal spikes is to employ at least in part said one or more contextual signal samples in connection with a probability computation.

16. The system of claim 15, wherein said probability computation is to employ an expectation maximization approach.

17. An article comprising:
a non-transitory computer readable storage medium with instructions executable to: identify a transition event to be based, at least in part, on detection of one or more temporal spikes to correspond to a topic and to be based, at least in part, on an association of one or more contextual signal samples with the one or more temporal spikes.

18. The article of claim 17, wherein said one or more contextual signal samples are to comprise one or more hashtag signal sample values.

19. The article of claim 17, further comprising instructions executable to cluster mentions of said topic to be based, at least in part, on said one or more temporal signal samples.

20. The article of claim 17, further comprising instructions executable to: use a superposition of Gamma functions to approximate a rise and/or fall pattern of mentions of said topic; and
wherein said association of one or more contextual signal samples with the one or more temporal spikes are to employ at least in part said one or more contextual signal samples in connection with a probability computation.
